(19) United States
(12) Patent Application Publication
(10) Pub. No.: US 2009/0047455 A1
(43) Pub. Date: Feb. 19, 2009

(54) Polymeric Film, a Process for Obtaining and Treating a Polymeric Film, and a Package

(76) Inventor: Angel Visentim Ortiz, Sao Paulo (BR)

Correspondence Address: TRASK BRITT, P.O. BOX 2550, SALT LAKE CITY, UT, 84110, US

(21) Appl. No.: 12/083,019

(22) PCT Filed: Oct. 3, 2006
(86) PCT No.: PCT/BR2006/000205

§ 371 Date: Jul. 23, 2008

(30) Foreign Application Priority Data
Oct. 3, 2005 (BR) PI0504232-1

(51) Int. Cl. B32B 27/16; B32B 27/34; B32B 27/08

(52) U.S. Cl. 428/35.7; 428/216; 264/473

(57) ABSTRACT

The present invention relates to a polymeric film, particularly designed for use on packages, irradiated with at least an amount of ionizing radiation (2) sufficient to increase the barrier to gases, the dose of energy deposited onto it ranging substantially from 10 to 150 kGy, and its mechanical properties undergoing an alteration equal to or lower than 20%.

The present invention relates to a polymeric film, particularly for use as package for food products, which has improved properties of impermeability to gases, as well as to a process for obtaining and treating this polymeric film, with a view to improving its barrier characteristics and, finally, to a package made from the polymeric-film.

### DESCRIPTION OF THE PRIOR ART

Polymeric films are products that have a very wide variety of uses in the most varied areas, among which packages is undoubtedly one of the most important.

The use of polymeric films as packages or for packages is extremely advantageous in view of the numerous qualities of these products, among which we can cite low cost, easy handling, broad variety of colors, patterns and textures, high transparency or opacity (as desired) and great safety provided by them, among others.

There are still some polymeric films that have other extremely desirable properties, such as high resistance to abrasion and perforation, low permeability to gases and vapors, which make these products extremely suitable for packages for food products, for example.

As a rule, food products should remain insulated from gases and vapors existing in the outer environment, chiefly oxygen gas, which, if in contact with the food, may oxidize it, reduce its shelf-life and even alter its coloration. In the same way, this barrier property is important, since it prevents the product from losing water to the outer environment, thus contributing to maintain its taste, aspect and other properties.

All of this without considering that oxygen gas in media having a high water activity brings about an increase in the aerobic biologic activity in the food packed therein, decreasing its shelf-life prior to consumption.

With a view to improve these packages, chiefly as far as resistance to perforation and barrier to bases and vapors are concerned, various solutions for the constitution of films the compose such packages were proposed.

In particular, a well-established and widely-employed process for improving mechanical characteristics of polymeric films is the irradiation with ionizing radiation, be it in the form of electromagnetic energy or as electrons accelerated at extremely high speeds.

As examples, one can cite the following documents.

U.S. Pat. No. 4,064,296 discloses a multi-layer structure irradiated with better shrinking characteristics at high temperatures.

U.S. Pat. No. 4,737,391 discloses an equally multi-layer structure irradiated with better hot-sealing and strength properties.

There is still the possibility of altering only one of the layers of a complex package in order to associate the best characteristics without impairing the others, as described in document U.S. Pat. No. 5,055,328.

However, as already pointed out, in all these examples one observes only alterations of the thermomechanical behavior of the films thus obtained. In the present case, one has obtained an important alteration in chemical behavior of the material processed by ionizing radiation.

### OBJECTIVES OF THE INVENTION

The present invention has the objective of providing a polymeric film, preferably but not compulsorily designed for packing food products, which has a high barrier capacity obtained by treatment during the process of obtaining it.

Also, the present invention has the objective of providing a process for treating the polymeric film, especially the above-described polymeric film, which aims at providing it with efficient properties with regard to the capacity of barrier to gases and vapors, chiefly oxygen gas and water vapor.

Finally, it is an objective of the present invention to provide a package particularly for packing food products, provided with the presently aimed objective.

The objectives of the present invention may be achieved both by multi-layer structures and by films having only one layer.

### BRIEF DESCRIPTION OF THE INVENTION

The objectives of the present invention are achieved by means of a polymeric film, particularly designed for use on packages, irradiated with at least an amount of ionizing radiation to increase the barrier to gases, the dose of energy deposited on it ranging substantially from 10 to 150 kGy and the alterations of its mechanical properties undergoing an alteration equal to or lower than 20%.

Additionally, the objectives of the present invention are achieved by means of a process for obtaining and treating a polymeric film, particularly a polymeric film designed for use on packages, which comprises the following steps:
step (a): obtaining the film by an extrusion process; and
step (b): submitting the film to at least an amount of ionizing radiation so that the dose of energy deposited thereon will range substantially from 10 kGy (kJkg) and 150 kGy and the alterations of its mechanical properties will undergo an alteration equal to or lower than 20%.

Finally, the objectives of the present invention are achieved by means of a package, particularly for packing food products, constituted by the polymeric film as defined above, which is obtained and treated according to the obtainment and treatment process also defined above.

The present invention has, as main advantages, an increase in the barrier to gases of the polymeric film without the enhanced alteration of its mechanical properties, by depositing energy irradiated between 10 kGy and 150 kGy. Thus, the barrier of the film improves substantially and, as a result, one avoids using films having a higher manufacture cost for obtaining the same results.

### BRIEF DESCRIPTION OF THE DRAWINGS

The present invention will now be described in greater detail with reference to an embodiment represented in the drawings. The figures show:

FIG. 1 is a schematic view of the process of obtaining the polymeric film of the present invention;

FIG. 2 is a perspective schematic view of the film of the present invention and, in detail A one can see its schematic cross-section.

### DETAILED DESCRIPTION OF THE FIGURES

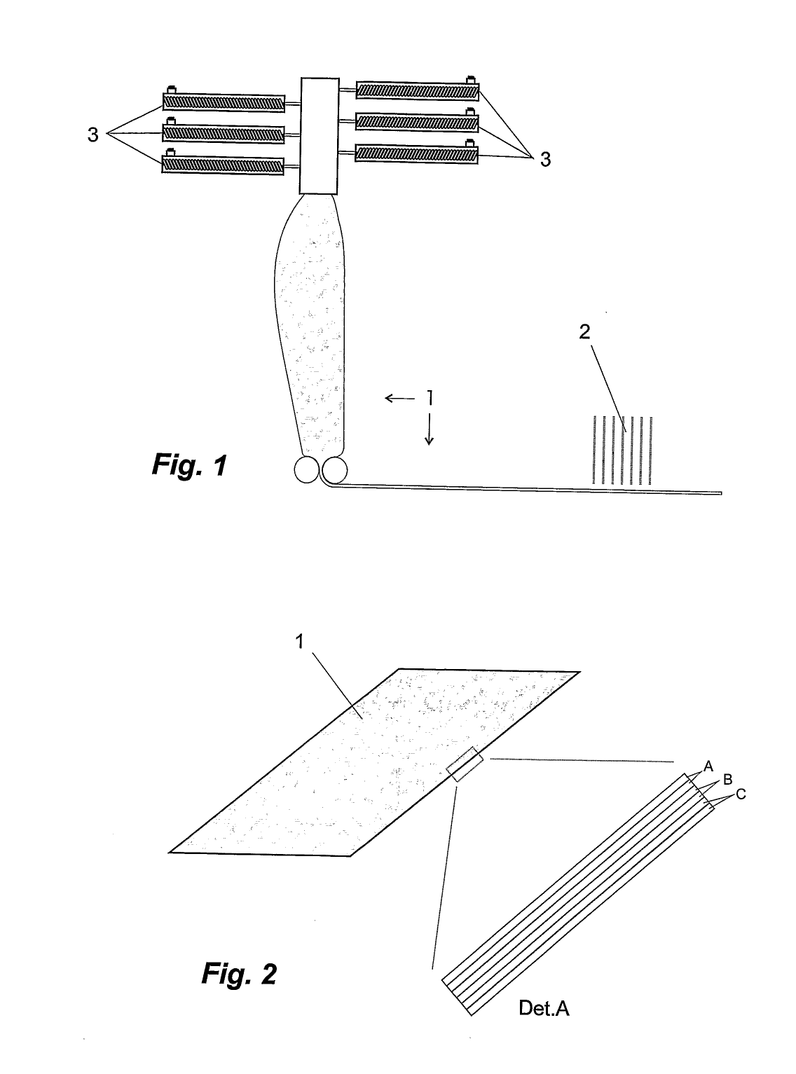

According to a preferred embodiment and as can be seen in FIGS. 1 and 2, the present invention relates to a polymeric film 1, particularly a multi-layer film designed chiefly for use on packages.

For use on packages, mainly food-product packages, a polymeric film must have some mechanical properties, such as resistance to perforations and abrasion, barrier to vapors and gases and, sometimes, high transparency.

The polymeric film 1 of the present invention has barrier-to-gas properties that are much incremented by application of ionizing radiation, as will be mentioned later.

Essentially the film 1 comprises at least one polymeric layer, but one may associate more parallel and adjacent layers, in order to achieve other objectives, beside the one described now.

By preference, the film 1 is composed by a polyamide (PA 6, PA 6.12, PA 6.66, PA 11, PA 12 and mixtures thereof) or by extrusion of the latter and co-extrusion adhesives; but it is evident that other materials and various mixtures may be used, if necessary or desirable.

Also by preference and as the case may be, the film 1 is obtained by means of simultaneous co-extrusion of all its layers, on an equipment called simultaneous co-extruding machine (illustrated schematically in FIG. 1), which ahs two or more screws (or another equivalent element, shown in FIG. 1 as 3), warming the material until its melting point. The machine should be designed so that each raw material will be formed in insulation until the respective layer of the film 1 is formed; thence, its name “simultaneous co-extruder”.

An alternative process of obtaining a multi-layer polymeric film 1 is known to those skilled in the art as lamination, wherein at least two parallel and adjacent sheets are strongly adhered to each other. Evidently the film 1 may be made on any other equipment, if possible and necessary or desirable.

It is known that the irradiation of polymers involve two different and concurrent mechanisms: degradation and cross-linking of the polymeric molecules. By degradation one understands the breakdown of the molecule into smaller pieces, and by cross-linking one understands the reorganization into molecules having a bigger molecular mass, with a high degree of interlacement with one another.

With the cross-linking, the mechanical properties of the polymers improve, chiefly with regard to tensile strength, elongation rupture, thermal stability and others that end up making irradiated polymeric films a good option for employ on packages, in particular food packages.

On the other hand, degradation takes place the other way about: the mechanical properties are depreciated, but it has been found that these types of smaller molecular mass provide new possibilities of arrangement of the crystalline phase of the polymer, making it more compact and as a result more impermeable to the passage of gases.

Therefore, one should select the dose and the polymeric material to be processes by irradiation in such a way that a compromise between loss of mechanical properties and gain in barrier to gases will be achieved.

After being shaped, the film 1 of the present invention, no matter what configuration it has, is irradiated with a determined amount of ionizing radiation (represented in FIG. 1 with reference number 2). However, nothing prevents it from being irradiated at some other moment, as for instance, after the manufacture or imprint thereof has been completed.

The film 1 should be subjected to ionizing radiation in such a way that the dose of energy deposited onto it will be on the order of 10 kGy to 150 kGy. This amount of energy deposited onto the film 1 enables such structural rearrangement that the increase of the barrier to gases and vapors is considerable.

The quality and nature of the ionizing radiation may be both the electromagnetic waves of extremely high frequency and the ultraviolet radiation, X-ray or γ-ray, and particulate, like the fermions (electrons, muons and pions), or even heavy ions, as long as duly accelerated, so that they will have the capability of penetrating the polymeric film to be treated and provide the proposed benefits.

However, after application, the film should exhibit an alteration of its mechanical characteristics (such as tear strength, among others) not higher than 20%, since greater variations may render the use of the film 1 on packages disadvantageous and unsuitable.

The film 1 may be made available in any suitable manner, as for example, in the form of coils, sacks or any other.

The process for obtaining the film 1, in turn, comprises the following steps:

step (a): obtaining the film 1 by means of the extrusion process, with the proviso that, in the event of employing several parallel and adjacent layers associated with each other, one employs the co-extrusion process, which is already known and widespread among those skilled in the art (considering that, as mentioned before, the number of layers may vary);

step (b): submitting the film 1 to at least one quality of ionizing radiation 2 so that the dose of energy deposited onto it will range substantially from 10 kGy to 150 kGy and cause alterations of their mechanical properties in a percentage equal to or lower than 20%, as already pointed out before.

Finally, a package is also presented as a novel invention, particularly for packing food products, made from the film 1 defined herein and produced by the process also defined herein.

A non-limitative example of the scope application and obtainment of the present invention is a structure of 8 polymeric layers arranged adjacent and parallel to one another as follows:

| | | | |
|---|---|---|---|
| Layer 1 | PE | 25 | μm |
| Layer 2 | Co-extrusion adhesive | 12 | μm |
| Layer 3 | PA 6 | 9 | μm |
| Layer 4 | Co-extrusion adhesive | 8 | μm |
| Layer 5 | PA 6 | 7 | μm |
| Layer 6 | PA 6 | 7 | μm |
| Layer 7 | Co-extrusion adhesive | 12 | μm |
| Layer 8 | PE | 10 | μm |

After this film having been obtained by the co-extrusion process, it was irradiated with 120 kGy.

Comparing the degrees of permeability to oxygen gas of the film described herein with one that has not been irradiated, we can see that there was an improvement of 22% in the property, which results in films of better performance than those presently obtained.

The losses of mechanical characteristics are of about 18%, which still allows it to be employed on food packages, since it is capable of withstanding the packing and transporting procedures themselves and other abuses that the product may undergo until its final consumption.

The package, which is not illustrated in the figures, may have any desired configuration, as for example, in the form of sacks, in tubular form, or still any other suitable shape. One may further consider a package that has at least one portion composed of the polymeric film 1, even if it additionally has other portions composed of other materials (aluminum paper, cardboard, other polymers, etc.).

Preferred embodiments having been described, one should understand that the scope of the present invention embraces other possible variations, being limited only by the contents of the accompanying claims, which include the possible equivalents.

1. A polymeric film, particularly designed for use on packages, irradiated with ionizing radiation (2), the film being characterized that;
(i) it comprises the structure:
Layer 1, composed of polyethylene, with a thickness substantially of 25 μm;
Layer 2, composed of co-extrusion adhesive, with a thickness substantially of 12 μm;
Layer 3, composed of polyamide-6, with a thickness substantially of 9 μm;
Layer 4, composed of co-extrusion adhesive, with a thickness substantially of 8 μm;
Layer 5, composed of polyamide-6, with a thickness substantially of 7 μm;
Layer 6, composed of polyamide-6, with a thickness substantially of 7 μm;
Layer 7, composed of co-extrusion adhesive, with a thickness substantially of 12 μm;
Layer 8, composed of polyethylene, with a thickness substantially of 10 μm; and
(ii) the dose of energy deposited onto it ranges substantially from 10 to 150 kGy and that its tear strength have undergone an alteration equal to or lower than 20% and its permeability properties to oxygen gas improves 22%.

2. A process for obtaining and treating a polymeric film, particularly an ionized polymeric film for use on packages, characterized by comprising the following steps:
step (a): obtaining a film (1) by extrusion; and
step (b): submitting the film (1) to an ionizing radiation (2) so that the dose of energy deposited onto it will be substantially between 10 and 150 kGy and cause alterations of its tear strength by a percentage equal to or lower than 20% and its permeability properties to oxygen gas improves 22%.

3. A process according to claim 2, characterized in that the step (a) corresponds to the co-extrusion of a film having two or more layers.

4. The polymeric film of claim 1 wherein said film is an extruded film and said film has been formed into a package, particularly for packing food products.

5. The polymeric film of claim 4 wherein said film is a co-extrusion of film having at least two layers.

6. The process of claim 2 further including forming said film into a package, particularly for packing food products.

7. The process of claim 6 wherein said obtaining said film by extrusion corresponds to a co-extrusion of a film having at least two layers.
